(19) United States
(12) Patent Application Publication
(10) Pub. No.: US 2025/0289992 A1
(43) Pub. Date: Sep. 18, 2025

(54) EFFICIENT SURFACE FUNCTIONALIZATION FOR SCALE-UP SYNTHESIS OF JANUS CARBON NANOFLUIDS

(71) Applicant: ARAMCO SERVICES COMPANY, Houston, TX (US)

(72) Inventor: Wei Wang, Quincy, MA (US)

(73) Assignee: ARAMCO SERVICES COMPANY, Houston, TX (US)

(21) Appl. No.: 18/605,567

(22) Filed: Mar. 14, 2024

(51) Int. Cl. C09K 8/58

(52) U.S. Cl. CPC C09K 8/58

(57) ABSTRACT

A method of preparing an enhanced oil recovery composition is provided. The method includes carbonizing a waste carbon material to provide carbon microparticles having a hydrophobic surface, functionalizing the carbon microparticles with an alkaline solution such that the carbon microparticles have a hydrophilic surface, and grinding the carbon microparticles to provide carbon nanoparticles. The carbon nanoparticles have a hydrophilic surface and a hydrophobic surface. The method may further include mixing the carbon nanoparticles with an aqueous based fluid to provide an enhanced oil recovery fluid.

### BACKGROUND

Among the major challenges in the modern world, meeting energy needs and protecting the environment are two of the top ranked. In addressing our ever-growing energy needs, conventional fossil fuels are still the primary energy source; however, they are becoming harder to extract from mature fields. Recent developments in petroleum engineering research have shown that nanomaterials may be used in water flooding techniques in oilfields, often referred to as nanofluid flooding, to improve oil displacement. One advantage of nanofluids arises from the small size of the included nanomaterials, that are able to alter the wettability of the reservoir rocks and/or change interfacial tension (IFT) at water-oil interface to increase oil recovery. However, various constraints influence the fluid-fluid and fluid-rock interactions of current nanofluids and subsequent oil recovery.

Likewise, whereas environmental protection is a longstanding goal, plastic waste material and biomass waste, two of the most abundant waste materials in the modern world, are highly durable and difficult to degrade. Thus, the development of efficient strategies for the reuse and recycling of waste materials has become a major goal across industries.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method of preparing an enhanced oil recovery composition. The method comprises carbonizing a waste carbon material to provide carbon microparticles having a hydrophobic surface, functionalizing the carbon microparticles with an alkaline solution such that the carbon microparticles comprise a hydrophilic surface, and grinding the carbon microparticles to provide carbon nanoparticles, wherein the carbon nanoparticles comprise a hydrophilic surface and a hydrophobic surface. The method may further comprise mixing the carbon nanoparticles with an aqueous based fluid to provide an enhanced oil recovery fluid.

In another aspect, embodiments disclosed herein relate to a method of enhanced oil recovery. The method comprises introducing an enhanced oil recovery composition into a hydrocarbon-bearing formation; displacing hydrocarbons from the hydrocarbon-bearing formation, and recovering the hydrocarbons. The enhanced oil recovery fluid includes carbon nanoparticles having a hydrophilic surface and a hydrophobic surface.

Other aspects and advantages of the claimed subject matter will be apparent from the following description and the appended claims.

### BRIEF DESCRIPTION OF DRAWINGS

FIG. 1 is a block-flow diagram of a method in accordance with one or more embodiments of the present disclosure.

FIG. 2 is a schematic illustration of carbonizing waste carbon material in accordance with one or more embodiments of the present disclosure.

FIG. 3 is a schematic illustration of functionalizing carbon microparticles in accordance with one of more embodiments of the present disclosure.

FIG. 4 is a schematic illustration of a carbon nanoparticle before and after grinding in accordance with one or more embodiments of the present disclosure.

FIG. 5 is a schematic illustration of a well environment in accordance with one or more embodiments of the present disclosure.

FIG. 6 is a block-flow diagram of a method in accordance with one or more embodiments of the present disclosure.

FIGS. 7A-7C are images of carbon particles produced from lignin powder and dispersed in hexane-water mixture: (a) non-functionalized carbon microparticles, (b) functionalized carbon microparticles, and (c) Janus carbon nanoparticles after grinding.

FIGS. 8A-8C are images of carbon particles from waste coffee powder and dispersed in toluene-water: (a) non-functionalized carbon microparticles, (b) functionalized carbon microparticles, and (c) Janus carbon nanoparticles after grinding.

FIG. 9 shows Raman spectroscopy data for untreated and KOH treated particles.

### DETAILED DESCRIPTION

Recent developments in enhanced oil recovery (EOR) techniques have demonstrated the effective use of nanotechnology in EOR fluids to improve oil recovery. Generally, nanomaterials included in EOR fluid can resist high temperature and pressure in subsurface oil reservoir system and exhibit different surface properties compared to organic molecules in porous media such as reservoir rocks, providing access to oil that is unreachable by surfactants and polymers conventionally used in EOR processes. Based on the specific physical characteristics and properties of a given nanomaterial, additional benefits of using such technology may include the ability to alter the wettability of minerals, decrease the interfacial tension (IFT) at the oil-water interface, change the viscosity of fluids, and/or generate structural disjoining pressure at the oil/rock interface.

Specifically, Janus nanomaterials whose surfaces have two or more distinct chemical or physical properties, hold dual nanoparticle and surfactant-like properties. Accordingly, the development of economical and sustainable methods to produce field quantities of low-cost nanomaterials would be very beneficial.

Waste material containing carbon such as plastics are ubiquitous in modern society. Plastics are made of a wide range of synthetic polymeric materials that often degrade very slowly. Since most of the polymers are formed from chains largely containing carbon atoms, this makes them excellent precursors for carbon materials, such as, for example, carbon nanoparticles. Biomass waste is also considered a waste carbon material. Biomass waste is a natural organic carbon source, mainly composed of organic macro-molecules such as cellulose, hemicellulose, lignin, polysaccharides and proteins. Most of the biomass waste is currently discarded, landfilled or openly burned, which not only leads to a waste of resources but also may cause environmental problems. As biomass waste is renewable, environmentally friendly, and abundantly available, it serves as an innocuous carbon source for carbon nanoparticle production.

As EOR nanofluids may exhibit improved oil recovery compared to conventional fluids, carbon nanoparticles derived from waste carbon materials such as waste plastics or biomass waste materials may be used in compositions and methods for EOR. Janus structured carbon nanoparticles may provide additional advantages as EOR nano-agents. Such compositions and methods would help address two major challenges in the modern world, namely, increasing energy needs and environmental protection. Accordingly, the present invention relates to a method of preparing carbon nanoparticles from waste carbon materials, as well as a composition and method of EOR using such carbon nanoparticles.

### Method of Preparing Eor Composition

In one aspect, embodiments disclosed herein relate to a method of preparing a EOR composition including Janus carbon nanoparticles. In particular, the Janus carbon nanoparticles may be prepared from a waste carbon material, and as such, the method may double as a method for reusing waste carbon material. The method may include carbonizing the waste carbon material to form hydrophobic carbon microparticles, functionalizing the carbon microparticles to generate hydrophilic surfaces, and grinding the carbon microparticles to provide Janus carbon nanoparticles with asymmetric amphiphilic surface properties.

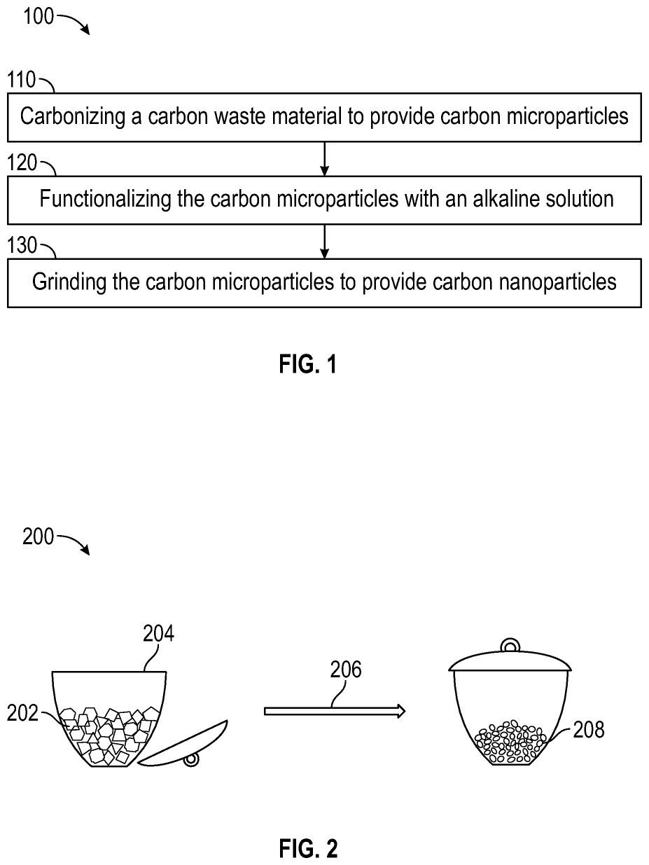

A method 100 for preparing an EOR composition including Janus carbon nanoparticles in accordance with one or more embodiments is shown in FIG. 1 and further discussed in FIGS. 2, 3, and 4. Initially, method 100 at block 110 includes carbonizing through a waste carbon material through a pyrolytic process to provide carbon microparticles. As used herein, “carbonize” refers to a process in which a carbon-containing material, such as the aforementioned waste carbon material, is converted or “carbonized” to a material at high temperature under inert atmosphere, or a material that is largely composed of amorphous carbon. The carbon waste material may be any waste plastic material or biomass waste that contains carbon. The carbon may be in hydrocarbons, aromatic rings, and combinations thereof.

Suitable waste plastic materials that may be carbonized include polymers such as polypropylene (PP), polystyrene (PS), acrylonitrile butadiene styrene (ABS), polyethylene terephthalate (PET), polyester (PES), polyamide (PA), polyvinyl chloride (PVC), polyurethane (PU), polycarbonate (PC), polyvinylidene chloride (PVDC), polyethylene (PE), and combinations thereof. In some embodiments, the waste plastic material includes PET, PP, PVC, PS, high-density polyethylene (HDPE), or low-density polyethylene (LDPE). The waste plastic material may be a post-consumer waste plastic material such as, for example, a plastic water bottle.

Suitable biomass wastes that may be carbonized include seaweed, algae, coffee, tea leaves, fruit peels, shells of nuts, flour, grains, straw, stover, eggs, milks, vegetable oils, animal meats, and combinations thereof. In particular embodiments, the biomass waste contains molecules of starch, chitin, lignin, cellulose, triglycerides, fatty acids, and combinations thereof.

In one or more embodiments, prior to being carbonized, the waste carbon material is processed. The waste plastic material may be processed to provide plastic fragments by cutting, grinding or cryogenic grinding the waste plastic material. In embodiments in which cryogenic grinding is utilized, liquid N₂ cooled samples may be ground using a suitable mill (e.g., SPEX sampleprep 6775 freezer/mill) with a suitable grinding speed (e.g., 10 counts per second (cps)). The waste plastic material may be processed into plastic fragments having a suitable size. For example, in one or more embodiments, plastic fragments have a suitable size ranging from millimeter to submillimeter sizes, for example, 1×1×1 mm, 0.5×0.5×5 mm, or 0.1×0.1×0.1 mm, etc. The biomass waste may be processed to provide dried small pieces of biomass waste of a dimension equal to less than a millimeter. In some embodiments, the biomass waste may be a dry powder. The biomass waste may be processed by any means known in the art.

FIG. 2, according to one or more embodiments, depicts an exemplary carbonizing process 200. Carbonization of the waste carbon material may be carried out according to any method known in the art. For example, and as shown in FIG. 2, carbonizing 200 waste carbon material 202 may be conducted in a crucible 204. Waste carbon material 202 may be carbonized in a furnace as represented by the arrow 206 in FIG. 2. In one or more embodiments, the waste carbon material is carbonized by heating to an elevated temperature for an amount of time in inert atmosphere such as nitrogen (N₂) or argon (Ar) or under vacuum. The elevated temperature may range from 300 to 550° C. in the carbonization process. For example, in one or more embodiments the waste carbon material is carbonized at an elevated temperature ranging from a lower limit of one of 300, 325, 350, 375, 400, and 425° C. to an upper limit of one of 425, 450, 475, 500, 525, and 550° C., where any lower limit may be paired with any mathematically compatible upper limit.

As described above, the waste carbon material may be heated at the elevated temperature for an amount of time to achieve carbonization. In one or more embodiments, the waste carbon material may be heated for an amount of time ranging from about 15 to about 60 minutes. For example, carbonization of the waste carbon material may take an amount of time ranging from a lower limit of one of 15, 20, 35, 30, and 35 minutes to an upper limit of one of 40, 45, 50, 55, and 60 minutes, where any lower limit may be paired with any mathematically compatible upper limit.

Carbonizing 200 may produce amorphous carbon microparticles 208. Carbonization of the waste carbon material may be confirmed using analytical methods known in the art. In particular, spectroscopies such as Raman spectroscopy, ¹H NMR spectroscopy, ¹³C NMR spectroscopy, scanning electron microscope (SEM) equipped with energy-dispersive X-ray spectroscopy (EDS), infrared (IR) spectroscopy, among others, may be used to characterize the carbonized waste material and confirm the chemical structure.

The carbonized waste material may be further processed to provide a powder. In one or more embodiments, the carbonizing 200 is followed with grinding in an agate mortar or ball mill to provide a powder or using other grinding methods known in the art. In embodiments in which ball milling is used, dry carbon powder may be ground in a suitable ball mill (e.g., Retsch IM 500 nano machine) at a suitable rate (e.g., 35 Hz) for a time ranging from 30 to 120 minutes. The powder may include particles having an average particle size in the micrometer (μm) range. As such, the powder may also be referred to herein as “carbon microparticles.”

Carbon microparticles 208 disclosed herein may have an average particle size of about 5.0 to about 500 μm. The size of particles can be measured by scanning electron microscope (SEM), transmission electron microscope (TEM), or by dynamic light scattering (DLS) method. In one or more embodiments, the carbon microparticles 208 may have an average particles size ranging from a lower limit of one of 5.0, 10, 50, 100, 150, 200, and 250 μm to an upper limit of one of 250, 300, 350, 400, 450 and 500 μm, where any lower limit may be paired with any mathematically compatible upper limit. In particular embodiments, the carbon microparticles 208 have an average particle size of about 10 μm.

Carbon microparticles 208 disclosed herein may have an average surface area of 2 to 50 m²/g. Surface area may be measured using any method known in the art. In one or more embodiments, the surface area is measured with a Brunauer-Emmett Teller (BET) surface analysis technique. Carbon microparticles 208 disclosed herein may have a hydrophobic surface.

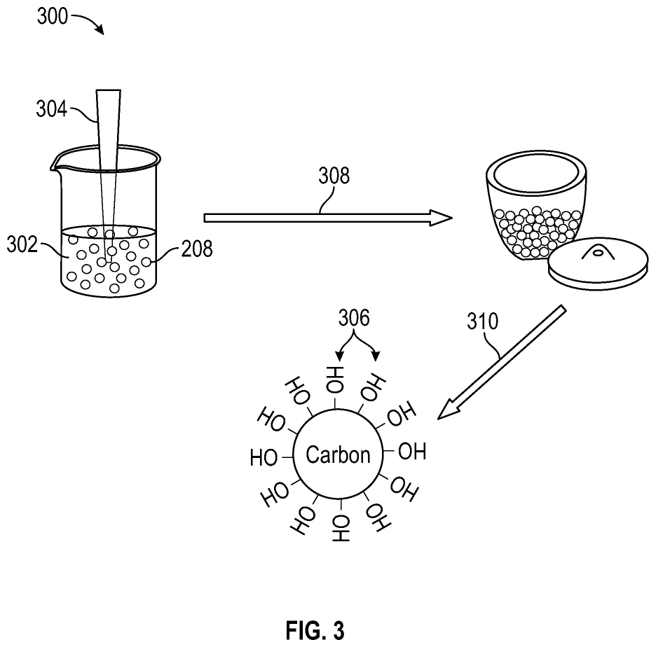

Method 100 at block 120 includes functionalizing the carbon microparticles with an alkaline solution. FIG. 3 depicts an exemplary embodiment of functionalizing 300. The carbon microparticles may be functionalized to provide a hydrophilic functionality on the surface of the microparticles. Such a hydrophilic surface 306 may exhibit strong hydrogen bonding ability. Suitable hydrophilic surface 306 functionalities include hydroxides.

Functionalizing 300 of the carbon microparticles 208 may include contacting the carbon microparticles with the alkaline solution 302. In one or more embodiments, the alkaline solution 302 is a potassium hydroxide (KOH) solution. The alkaline solution may have a solvent of a 1:1 by volume mixture of water and ethanol. In one or more embodiments, the ratios of solvent (water to ethanol) may vary from 1:9, 2:8, 3:7, 4:6 or 6:4, 7:3, 8:2 and 9:1. In one or more embodiments, the concentration of the alkaline solution is of a range of 1.0 to 4.0 M.

The carbon microparticles 208 may undergo ultrasonication with a tip sonicator 304 for an amount of time while in contact with the alkaline solution. The time of ultrasonication may range from 1 to 15 minutes. In one or more particular embodiments, the tip sonicator (e.g., Fisher Scientific, Model CL-18) may be operated at 120 Watt and 20 KHz.

After ultrasonication, the carbon microparticles 208 may be separated as represented by arrow 308 from the alkaline solution 302 and dried at 100° C. Once dried, the carbon microparticles are heated as represented by arrow 310 in a furnace as previously described with the carbonizing of the waste carbon material. The second carbonization may be at an elevated temperature ranging from a lower limit of one of 300, 325, 350, 375, 400, and 425° C. to an upper limit of one of 425, 450, 475, 500, 525, and 550° C., where any lower limit may be paired with any mathematically compatible upper limit. The second carbonization may take an amount of time ranging from a lower limit of one of 15, 20, 35, 30, and 35 minutes to an upper limit of one of 40, 45, 50, 55, and 60 minutes, where any lower limit may be paired with any mathematically compatible upper limit. In one or more embodiments, after heating, functionalized carbon microparticles with a hydrophilic surface 306 are produced.

After the surface functionalization, the carbon microparticles that were previously hydrophobic can be well-dispersed in water, implying homogeneous hydrophilic functionalization of the carbon surface. The functionalized carbon surface may be confirmed using analytical methods known in the art. In particular, FTIR spectroscopy may be used to characterize the functionalized carbon microparticles in comparison with pristine carbon microparticles. In other embodiments, a Langmuir isotherm, for example a surface pressure-surface area curve or a π-A curve, may be measured at the water/air interface with a Langmuir trough.

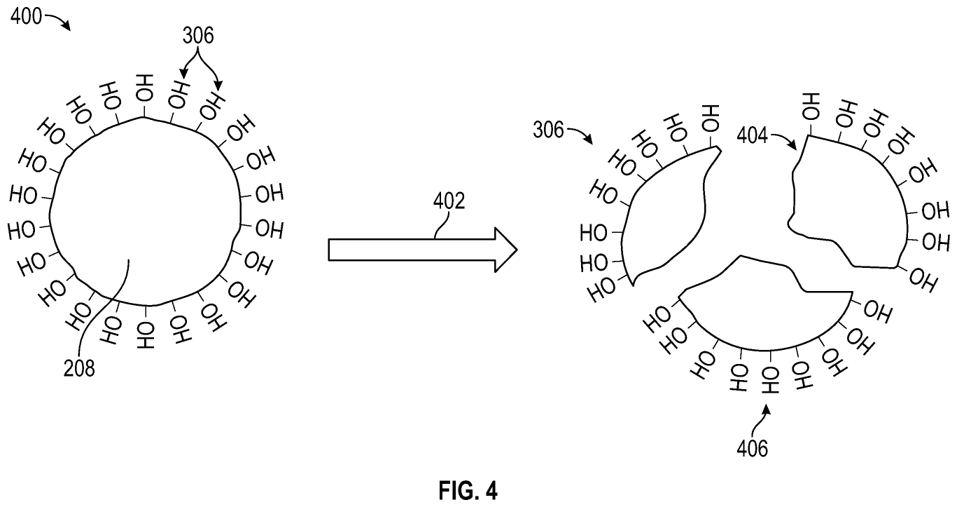

Method 100 at block 130 further includes grinding the functionalized carbon microparticles. FIG. 4 depicts an exemplary embodiment of a grinding process 400. The grinding process 400 may be conducted using a ball mill, for example. In one more more particular embodiments, the bill mill may be the Netzsch MiniCer with 0.5 mm grinding beads for wet samples. A lubricant may be included in the mixture to be milled in the ball mill. Lubricants may include glycol, ethanol, water, and combinations thereof. The ball mill may also include grinding media. Grinding media may include zirconia, tungsten carbide, silicon carbide, alumina, steel balls, and combinations thereof. The grinding media may have an average diameter that is larger than that of the functionalized carbon microparticles. For example, the particles of the grinding media may have a diameter on the submillimeter or micrometer scale.

Carbon microparticles 208 with a hydrophilic surface 306 may become smaller particles by a milling process 402, such as ball milling as noted above. Ball milling 402 may occur over a time period of 0.5 to 8 hours. In one or more embodiments, the functionalized carbon microparticles are milled for an amount of time ranging from a lower limit of one of 0.5, 1.0, 1.5, 2.0, 2.5, 3.0, 3.5, and 4.0 hours to an upper limit of one of 4.5, 5.0 hours, where any lower limit may be paired with any mathematically compatible upper limit.

Ball milling 402 may be conducted with a milling speed in the range of 2000 to 4000 rpm (rotations per minute). In one or more embodiments, the milling speed may range from a lower limit of one of 2000, 2200, 2400, 2600, 2800, and 3000 rpm to an upper limit of one of 3000, 3200, 3400, 3600, 3800, and 4000 rpm, where any lower limit may be paired with any mathematically compatible upper limit.

As described above, grinding 400 the functionalized carbon microparticles may provide carbon nanoparticles 406. In particular, the carbon nanoparticles 406 are produced by breaking up the functionalized carbon microparticles into smaller, nanosized particles with asymmetric surface functionalization, i.e., Janus carbon nanoparticles. As the Janus carbon nanoparticles are broken pieces of the functionalized carbon microparticles, they may have a hydrophilic surface 306, originating from the hydrophilic surface of the functionalized carbon microparticles, and a hydrophobic surface 404, originating from the core of the carbon microparticles 208, which is composed of amorphous carbon. Thus, ball milling 402 may produce carbon nanoparticles 406 with both a hydrophilic surface 306 and a hydrophobic surface 404. In one or more embodiments, the hydrophilic surface 306 of the carbon nanoparticles includes a hydrophilic functionality that is the same as the hydrophilic functionality of the functionalized carbon microparticles. On the other hand, the hydrophobic surface 404 of the carbon nanoparticles 406 may be comprised primarily of carbon.

In one or more embodiments, the Janus carbon nanoparticles 406 have an average particle size ranging from about 10 to 2,000 nm, as measured by scanning electron microscopy (SEM). Carbon nanoparticles 406 prepared according to the disclosed method may have an average particle size ranging from a lower limit of one of 10, 50, 100, and 500 nm to an upper limit of one of 600, 1000, 1500 and 2,000 nm, where any lower limit may be paired with any mathematically compatible upper limit. The carbon nanoparticles 406 disclosed herein may have an average surface area of 10 to 500 m²/g.

As described above, Janus carbon nanoparticles in accordance with the present disclosure have a hydrophilic surface and a hydrophobic surface. As such, the disclosed Janus carbon nanoparticles may have unique properties, such as surfactant-like surface properties. For example, as characterized according to Langmuir isotherm, the present carbon nanoparticles may exhibit an adsorption similar to that of conventional surfactants. Surfactants are widely used in enhanced oil recovery for their dual hydrophobic and hydrophilic nature. Accordingly, Janus carbon nanoparticles of one or more embodiments may be beneficial to EOR processes when incorporated in EOR fluid compositions.

Embodiments disclosed herein also relate to a composition for EOR. The composition may include a nanomaterial and an aqueous-based fluid. In one or more embodiments, the nanomaterial in the EOR composition is the carbon nanoparticles described above.

The EOR composition may include the Janus carbon nanoparticles in an amount ranging from about 0.001 wt % (weight percent) to about 3.0 wt % based on the total weight of the EOR composition. For example, in one or more embodiments, Janus carbon nanoparticles are present in the EOR nanofluid in an amount ranging from a lower limit of one of 0.001, 0.005, 0.01, 0.05, and 0.1 wt % to an upper limit of one of 0.5, 1.0, 1.5, 2.0, 2.5, and 3.0 wt %, where any lower limit may be paired with any mathematically compatible upper limit.

In one or more embodiments, the EOR composition includes an aqueous-based fluid. The aqueous-based fluid includes water. The water may be distilled water, deionized water, tap water, fresh water from surface or subsurface sources, production water, formation water, natural and synthetic brines, brackish water, natural and synthetic sea water, black water, brown water, gray water, blue water, potable water, non-potable water, other waters, and combinations thereof, that are suitable for use in a wellbore environment. In one or more embodiments, the water used may naturally contain contaminants, such as salts, ions, minerals, organics, and combinations thereof, as long as the contaminants do not interfere with the operation of the drilling fluid.

In one or more embodiments, the EOR composition includes water in a range of from about 97 wt % to 99.9 wt % based on the total weight of the EOR composition. In one or more embodiments, the water used for the EOR composition may have an elevated level of salts or ions versus fresh water, such as salts or ions naturally present in formation water, production water, seawater, and brines. Without being bound by any particular mechanism or theory, increasing the saturation of water by increasing the salt concentration or other organic compound concentration in the water may increase the density of the water, and thus, the EOR composition. Suitable salts may include, but are not limited to, alkali metal halides, such as chlorides, hydroxides, or carboxylates. In one or more embodiments, salts included as part of the aqueous-based fluid may include salts that disassociate into ions of sodium, calcium, cesium, zinc, aluminum, magnesium, potassium, iron, copper, strontium, silicon, lithium, chlorides, bromides, carbonates, iodides, chlorates, bromates, formates, nitrates, sulfates, phosphates, hydroxides, and fluorides, and combinations thereof.

In one or more embodiments, the EOR composition includes one or more salts in an amount that ranges from about 0 to about 225,000 ppm (parts per million) in TDS (total dissolved solids). For example, the EOR composition may contain the one or more salts in an amount ranging from a lower limit of any of 0, 5,000, 10,000, 20,000, 30,000, 50,000, 75,000, 100,000 and 125,000 ppm to an upper limit of any of 125,000, 150,000, 175,000, 200,000, and 225,000 ppm, where any lower limit can be used in combination with any mathematically compatible upper limit.

In one or more embodiments, the EOR composition includes one or more additives. Any additives known in the art for EOR compositions may be used. Examples of such additives include but are not limited to surfactants, polymers, stabilizers, and/or mixtures thereof. In one or more embodiments, additives may be included in the EOR composition in an amount ranging from 0 to about 3 wt % based on the total weight of the EOR composition.

In one or more embodiments, the EOR nanofluid may be characterized according to several properties, such as, for example, viscosity, density, and homogeneity. Further, the presence of the carbon nanoparticles in the fluid, may result in a decreased interfacial tension between the EOR fluid and the oil within a reservoir.

### Enhanced Oil Recovery Method

In another aspect, embodiments of the present disclosure relate to a method of enhanced oil recovery using an enhanced oil recovery composition described above. The method may include introducing an enhanced oil recovery composition into a hydrocarbon-bearing formation, displacing hydrocarbons from the hydrocarbon-bearing formation, and recovering the hydrocarbons.

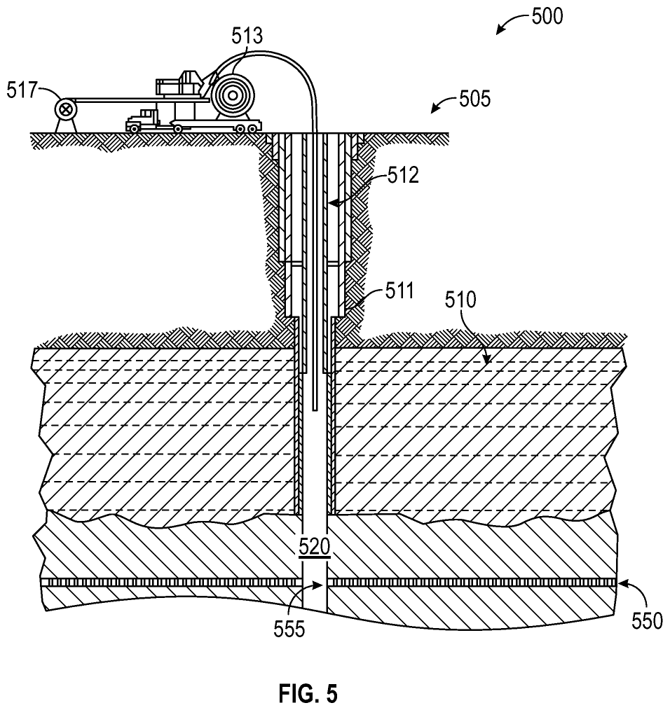

FIG. 5 depicts a well environment 500 in accordance with one or more embodiments. Well environment 500 includes a subsurface 510. Subsurface 510 is depicted having a wellbore wall 511 both extending downhole from a surface 505 into the subsurface 510 and defining a wellbore 520. The subsurface 510 also includes target formation 550 to be treated. Target formation 550 has target formation face 555 that fluidly couples target formation 550 with wellbore 520 through wellbore wall 511. In this case, casing 512 and coiled tubing 513 extend downhole through the wellbore 520 into the subsurface 510 and towards target formation 550. With the configuration in FIG. 5, the previously described embodiment that comprises the enhanced oil recovery composition may be introduced into the subsurface 510 and towards target formation 550 via a pump 517 through the coiled tubing 513.

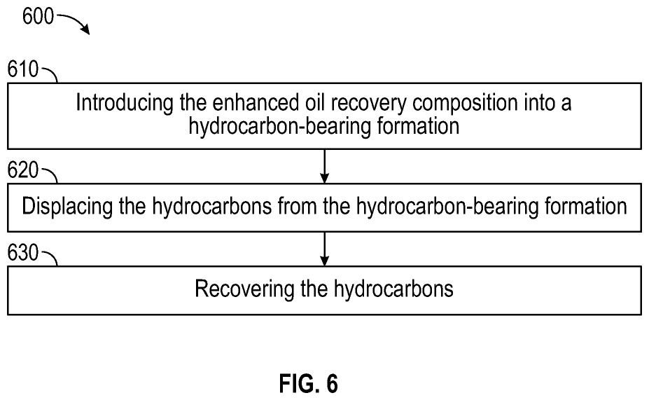

A method, 600, in accordance with the present disclosure is shown in, and discussed with reference to, FIG. 6. Initially, in step 610, an enhanced oil recovery composition is introduced into a hydrocarbon-bearing formation. In one or more embodiments, the EOR composition is introduced into the subsurface 510 of the target formation 550. The EOR nanofluid is as previously described. The hydrocarbon-bearing formation may include oil. In one or more embodiments, the hydrocarbon-bearing reservoir has already been depleted of about a third of its hydrocarbon content.

In method 600, step 620 includes displacing the hydrocarbons in the hydrocarbon-bearing foundation. The hydrocarbon may be displaced using the disclosed EOR composition. In one or more embodiments, the Janus carbon nanoparticles may have a surfactant-like surface property in the EOR composition. Accordingly, disclosed Janus carbon nanoparticles may reside at the oil-water interface or at the rock-fluid interface downhole, and thus may increase the hydrocarbon mobility or alter the wettability of reservoir rock, resulting in increased hydrocarbon displacement.

Step 630 in method 600 includes recovering the hydrocarbons. As described above, in the presence of the disclosed EOR composition, the hydrocarbons may have an increased mobility and thus an increased hydrocarbon recovery from the formation. Method 600 may result in greater recovery of oil initially in place (OIIP).

Embodiments of the present disclosure may provide at least one of the following advantages. The use of an alkaline solution is a simple and economically feasible method for functionalizing carbon microparticles. The use of the alkaline solution may reduce the formation of excessive amounts of liquid and gas wastes as compared to other functionalization methods.

### EXAMPLES

### Example 1: Synthesis of Carbon Microparticles from Waste Plastic

In a typical synthesis, waste plastic water bottles (polymer PET) were cut into small pieces in millimeter size, and 10 grams of the plastic fragments were put into a crucible. After heating at 450° C. for 60 minutes under N₂ atmosphere, the resulting carbon black powder was collected. By grinding in a ball mill machine (Retsch IM 500 Nano) with 3 mm zirconia beads for 1 hour at 35 Hz with, the dry carbon powder was controllably broken down to size in micrometer range,

### Example 2: Synthesis of Carbon Microparticles from Waste Coffee Powder

In a typical synthesis, waste coffee powder was dried at 100° C. in oven under air, and then 10 grams of the dried coffee powder were transferred into a crucible. After heating at 450° C. for 60 minutes under N₂ atmosphere, the resulting carbon black powder was collected. By grinding in a ball mill machine, the dry carbon powder was controllably broken down to size in micrometer range.

### Example 3: Synthesis of Carbon Microparticles from Lignin

In a typical synthesis, 10 grams of dry lignin powder were placed into a crucible and heated at 450° C. for 60 minutes under N₂ atmosphere. The formed carbon black powder was collected and then ground by a ball mill machine. Carbon particles with a size in the micrometer range were obtained.

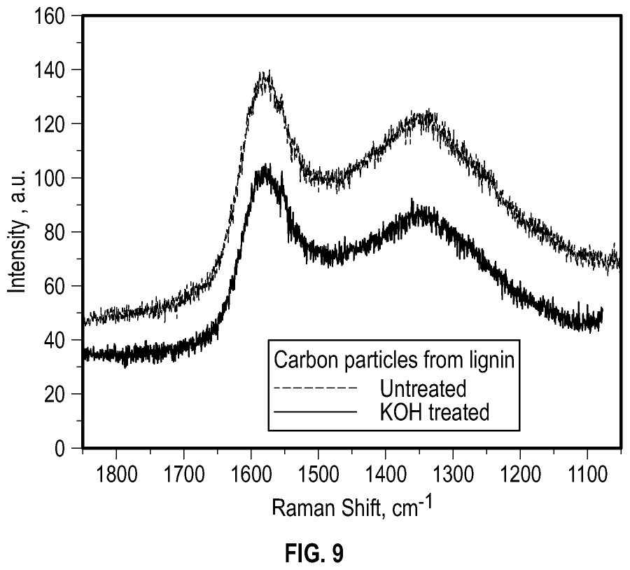

The formation of carbon structures in the above samples was confirmed by Raman spectroscopy with characteristic D-band at around 1365 cm⁻¹ and G-band at around 1605 cm⁻¹ as shown in FIG. 9.

### Example 4: Surface Functionalization with Alkaline Solution

Carbon microparticles were placed in a beaker (2 grams) and 50 mL of 1 M potassium hydroxide (KOH) solution in water-ethanol 1:1 mixture was added under magnetic stirring. A tip sonicator (Fisher Scientific Model CL-18, 120 Watt, 25 kHz) was applied to the solution with a paused sonication for 15 minutes. The KOH solution treated carbon microparticles were collected by filtration and dried under 100° C. in an oven in air, and then transferred into a tubing furnace and heated to 450° C. for 60 minutes in air and N₂. After cooling the sample down to room temperature, the resulting functionalized carbon microparticles had a surface with enhanced hydrophilicity and were easily dispersed into water.

### Example 5: Formation of Janus Carbon Microparticles

A laboratory-use ball mill (Netzsch, MiniCer) was used for grinding the carbon microparticles. A quantity equivalent of 140 mL of zirconia beads (diameter of 0.45 mm) were first loaded into the mill chamber as the grinding medium. Then, 10 grams of micron-sized carbon powder was mixed with 200 mL of water in an open mixing vessel and pumped to flow through milling chamber. The milling speed was set at 3000 rpm and the feed material fluids circulated in the milling chamber at a rate of 100 mL/min. After 2 hours of milling, the carbon nanoparticle fluids were collected, and carbon nanoparticles were separated by centrifuge and washed with ethanol.

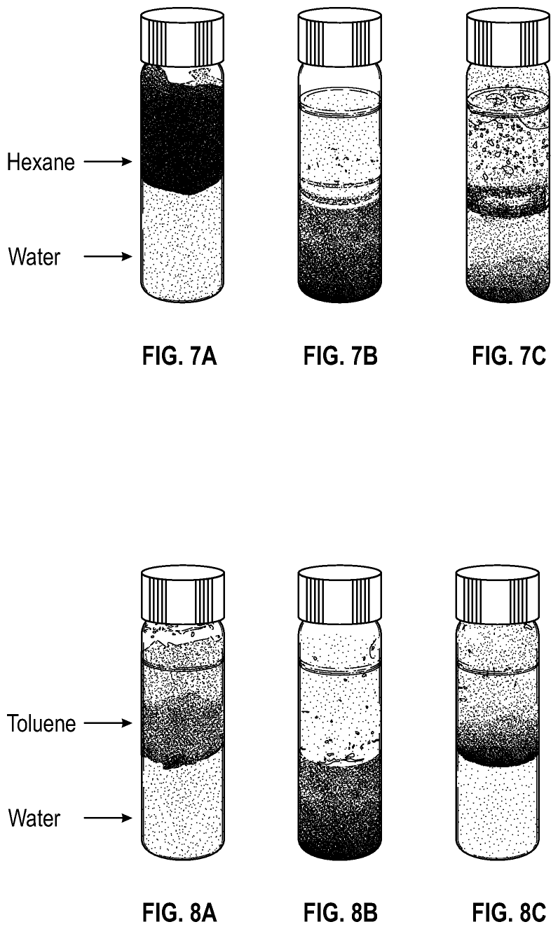

Photos of examples of the synthesized Janus carbon nanoparticles from lignin and waste coffee powder in a mixture of water-organic solvent are shown in FIGS. 7 and 8, respectively. It is clear that the as-synthesized carbon microparticles from both lignin and waste coffee powder are hydrophobic and are dispersed in organic solvents (part (a) of FIGS. 7 and 8). After treatment with KOH, the carbon microparticles turn to hydrophilic and are easily dispersed in water phase (part (b) of FIGS. 7 and 8). After grinding into nanosized particles, the carbon nanoparticles exhibit typical Janus properties and tend to assemble at the interface of water-organic solvent (part (c) of FIGS. 7 and 8).

The particle size and zeta potential (ζ-potential) of the produced carbon microparticles and Janus carbon nanoparticles in water suspensions were measured by dynamic light scattering method with a Brookhaven 90PLUS/PALS instrument, and results are summarized in Table 1.

TABLE 1
Particle sizes and zeta potentials of synthesized carbon
microparticles and Janus carbon nanoparticles

| | C-MPs | | C-MPs | | | |
|---|---|---|---|---|---|---|
| | (Before surface | | (After surface | | Janus C-NPs | |
| | functionalization) | | functionalization) | | (After ball milling) | |
| | | ζ- | | ζ- | | ζ- |
| Carbon | | potential, | Size, | potential, | Size, | potential, |
| precursor | Size, nm | mV | nm | mV | nm | mV |
| Waste coffee | ~1125 ± 28% | −8.5 ± 2.6 | ~1289 ± 21% | −56.2 ± 2.7 | ~680 ± 24% | −31.5 ± 3.1 |
| powder | | | | | | |
| Lignin | ~3608 ± 39% | −2.3 ± 3.7 | ~2100 ± 33% | −52.7 ± 3.2 | ~976 ± 41% | −19.6 ± 3.7 |
| powder | | | | | | |
| Waste plastic | ~6070 ± 43% | +3.7 ± 5.1 | ~3445 ± 31% | −47.3 ± 3.9 | ~1122 ± 38% | −21.4 ± 3.4 |
| (PTE) | | | | | | |

After the carbonization of the waste plastic material or biomass waste, the carbon powders could be ground into micron size in several micrometers and their surface charge densities were very low with zeta potentials from −8.5 mV to +3.7 mV. After the surface functionalization by KOH treatment at high temperature, the negative surface charge densities were highly enhanced to around −50 mV, while the particle sizes remain without much change. After the ball mill grinding treatment, the sizes of resulting Janus carbon nanoparticles were down to submicron sizes, and the surface charge densities were reduced to around −20 mV to −32 mV, due to the formation of asymmetric Janus nanostructures.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method of preparing an enhanced oil recovery composition comprising:
carbonizing a waste carbon material to provide carbon microparticles having a hydrophobic surface;
functionalizing the carbon microparticles with an alkaline solution such that the carbon microparticles comprise a hydrophilic surface; and
grinding the carbon microparticles to provide carbon nanoparticles, wherein the carbon nanoparticles comprise the hydrophilic surface and the hydrophobic surface.

2. The method of claim 1, further comprising mixing the carbon nanoparticles with an aqueous-based fluid to provide an enhanced oil recovery fluid.

3. The method of claim 1, wherein the waste carbon material comprises a waste plastic material or a biomass waste.

4. The method of claim 3, wherein the waste plastic material comprises a polymer selected from the group consisting of polypropylene (PP), polystyrene (PS), acrylonitrile butadiene styrene (ABS), polyethylene terephthalate (PET), polyester (PES), polyamide (PA), polyvinyl chloride (PVC), polyurethane (PU), polycarbonate (PC), polyvinylidene chloride (PVDC), polyethylene (PE), and combinations thereof.

5. The method of claim 3, wherein the waste plastic material is a plastic waste bottle.

6. The method of claim 3, wherein the biomass waste comprises a biomass waste selected from a group consisting of seaweed, algae, coffee, tea leaves, fruit peels, shells of nuts, and combinations thereof.

7. The method of claim 3, wherein the biomass waste comprises a molecule selected from a group of starch, chitin, lignin, cellulose, and combinations thereof.

8. The method of claim 1, wherein carbonizing the waste carbon material comprises heating the waste carbon material at a temperature in a range of 300 to 550° C.

9. The method of claim 1, wherein the carbon microparticles have an average particle size ranging 5 to 500 μm.

10. The method of claim 1, wherein functionalizing the carbon microparticles with the alkaline solution comprises ultrasonicating the carbon microparticles in the alkaline solution for an amount of time from 1 to 15 minutes.

11. The method of claim 10, wherein functionalizing the carbon microparticles with the alkaline solution further comprises heating the carbon microparticles after ultrasonicating at a temperature in a range of 300 to 550° C.

12. The method of claim 1, wherein the alkaline solution is a solution of potassium hydroxide.

13. The method of claim 1, wherein the alkaline solution has a concentration in a range of 1.0 to 4.0M.

14. The method of claim 1, wherein the hydrophilic surface functionality is a hydroxide.

15. The method of claim 1, wherein grinding the carbon microparticles comprises ball milling the carbon microparticles for an amount of time from 0.5 to 8 hours with a speed of 2000 to 4000 rpm.

16. The method of claim 1, wherein the carbon nanoparticles have an average particle size ranging from 10 to 2,000 nm.

17. The method of claim 2, wherein the aqueous-based fluid is water, seawater, or brine.

18. The method of claim 2, wherein the aqueous-based fluid comprises one or more additives selected from the group consisting of surfactant, stabilizers, and combinations thereof.

19. A method of enhanced oil recovery, comprising:
introducing the enhanced oil recovery composition of claim 2 into a hydrocarbon-bearing formation;
displacing hydrocarbons from the hydrocarbon-bearing formation; and
recovering the hydrocarbons.

20. The method of claim 19, wherein the carbon nanoparticles are present in an amount ranging from 0.001 to 3.0 wt %.
